(19) United States
(12) Patent Application Publication
(10) Pub. No.: US 2025/0315664 A1
(43) Pub. Date: Oct. 9, 2025

(54) METHOD AND DEVICE FOR CALCULATING SELF-ATTENTION MODULE

(71) Applicant: Montage Technology Co., Ltd., Shanghai (CN)

(72) Inventor: Xiaolei ZHANG, Shanghai (CN)

(21) Appl. No.: 19/172,689

(22) Filed: Jun. 13, 2025

(30) Foreign Application Priority Data
Apr. 8, 2024 (CN) 202410418632.3

(51) Int. Cl. G06N 3/0495; G06N 3/047

(52) U.S. Cl. CPC G06N 3/0495; G06N 3/047

(57) ABSTRACT

A method and a device for calculating a self-attention module are provided. The method includes: obtaining a query matrix Q, a key matrix K, and a value matrix V for calculating the self-attention module; quantizing at least one of the query matrix Q and the key matrix K to calculate a quantized correlation matrix M_{q}; dequantizing the quantized correlation matrix M_{q} to obtain a dequantized correlation matrix M_{deq}; processing the dequantized correlation matrix M_{deq} using a normalized exponential function to obtain an attention probability matrix A; and calculating a weighted attention matrix Attention(Q, K, V) of the self-attention module based on the attention probability matrix A and the value matrix V.

### TECHNICAL FIELD

This application relates to the field of neural networks, and more particularly, to a method and a device for calculating a self-attention module.

### BACKGROUND OF THE INVENTION

In recent years, neural network technology has been applied in various technical fields, such as image recognition, speech recognition, autonomous driving, medical imaging, and so on. A transformer model (such as the BERT model, the GPT model, etc.) is a deep neural network model based on self-attention mechanism, which can efficiently process sequence data in parallel and has been proven to have excellent performance in natural language processing (NLP). However, compared to traditional neural network models, the complexity and the number of parameters of the transformer model increase significantly, resulting in a sharp increase in their computational load. For example, the ChatGPT model based on the transformer model has 175 billion model parameters, and its computational load reaches 735 trillion floating-point operations per second (TFLOPS). An important reason for this large computational load is the need for calculating a large amount of self-attention modules in the transformer model. Therefore, it is desired to accelerate the calculation of the self-attention module.

### SUMMARY OF THE INVENTION

An object of the present application is to provide a method for accelerating the calculation of the self-attention module.

According to some aspects of the present application, a method for calculating a self-attention module is provided. The method may include: obtaining a query matrix Q, a key matrix K, and a value matrix V for calculating the self-attention module; quantizing at least one of the query matrix Q and the key matrix K to calculate a quantized correlation matrix M_{q}; dequantizing the quantized correlation matrix M_{q} to obtain a dequantized correlation matrix M_{deq}; processing the dequantized correlation matrix M_{deq} using a normalized exponential function to obtain an attention probability matrix A; and calculating a weighted attention matrix Attention(Q, K, V) of the self-attention module based on the attention probability matrix A and the value matrix V.

According to other aspects of the present application, a method for inferring input information is provided. The method may include: obtaining the input information and a neural network model, wherein the input information is generated based on natural language information or visual image information, and the neural network model includes a self-attention module; obtaining a query matrix Q, a key matrix K, and a value matrix V for calculating the self-attention module based on the input information; calculating the weighted attention matrix Attention(Q, K, V) of the self-attention module according to the above method for calculating the self-attention module; and using the weighted attention matrix Attention(Q, K, V) in a process of inferring the input information using the neural network model.

According to other aspects of the present application, an electronic device is provided. The electronic device may include: a processing component including a plurality of computing cores with different computing precisions; and a storage component configured for storing a computer program executable by the processing component, wherein, when the computer program is executed by the processing component, the processing component is caused to perform: obtaining a query matrix Q, a key matrix K, and a value matrix V for calculating a self-attention module; quantizing the query matrix Q and/or the key matrix K to obtain a quantized query matrix Q_{q} and/or a quantized key matrix K_{q}; selecting a computing core from the plurality of computing cores with different computing precisions, wherein a computing precision of the selected computing core corresponds to a precision of elements in the quantized query matrix Q_{q} and/or the quantized key matrix K_{q}; controlling the selected computing core to calculate a quantized correlation matrix M_{q} based on the quantized query matrix Q_{q} and/or the quantized key matrix K_{q}; dequantizing the quantized correlation matrix M_{q} to obtain a dequantized correlation matrix M_{deq}; processing the dequantized correlation matrix M_{deq} using a normalized exponential function to obtain an attention probability matrix A; and calculating a weighted attention matrix Attention(Q, K, V) of the self-attention module based on the attention probability matrix A and the value matrix V.

According to other aspects of the present application, a non-volatile computer-readable storage medium is provided. The non-volatile computer-readable storage medium may have stored therein instructions that, when executed by a processor, cause the processor to perform the above method for calculating the self-attention module.

The foregoing is a summary of the present application and may be simplified, summarized, or omitted in detail, so that a person skilled in the art shall recognize that this section is merely illustrative and is not intended to limit the scope of the application in any way. This summary is neither intended to define key features or essential features of the claimed subject matter, nor intended to be used as an aid in determining the scope of the claimed subject matter.

### BRIEF DESCRIPTION OF DRAWINGS

The abovementioned and other features of the present application will be more fully understood from the following specification and the appended claims, taken in conjunction with the accompanying drawings. It can be understood that these drawings depict several embodiments of the present application and therefore should not be considered as limiting the scope of the present application. By applying the drawings, the present application will be described more clearly and in detail.

FIG. 1 illustrates a block diagram of a self-attention module in the transformer model.

FIG. 2 illustrates a flowchart of a method 200 for calculating a self-attention module according to some embodiments of the present application.

FIG. 3 illustrates a flowchart for quantizing a query matrix and a key matrix according to some embodiments of the present application.

FIG. 4 illustrates a flowchart of a method 400 for calculating a temperature adjustment parameter according to some embodiments of the present application.

FIG. 5 illustrates a structural block diagram of an electronic device according to some embodiments of the present application.

FIG. 6 illustrates a structural block diagram of a streaming multiprocessor according to some embodiments of the present application.

### DETAILED DESCRIPTION OF THE INVENTION

The following detailed description refers to the drawings that form a part hereof. In the drawings, similar symbols generally identify similar components, unless context dictates otherwise. The illustrative embodiments described in the description, drawings, and claims are not intended to limit. Other embodiments may be utilized and other changes may be made without departing from the spirit or scope of the subject matter of the present application. It can be understood that numerous different configurations, alternatives, combinations and designs may be made to various aspects of the present application which are generally described and illustrated in the drawings in the application, and that all of which are expressly formed as part of the application.

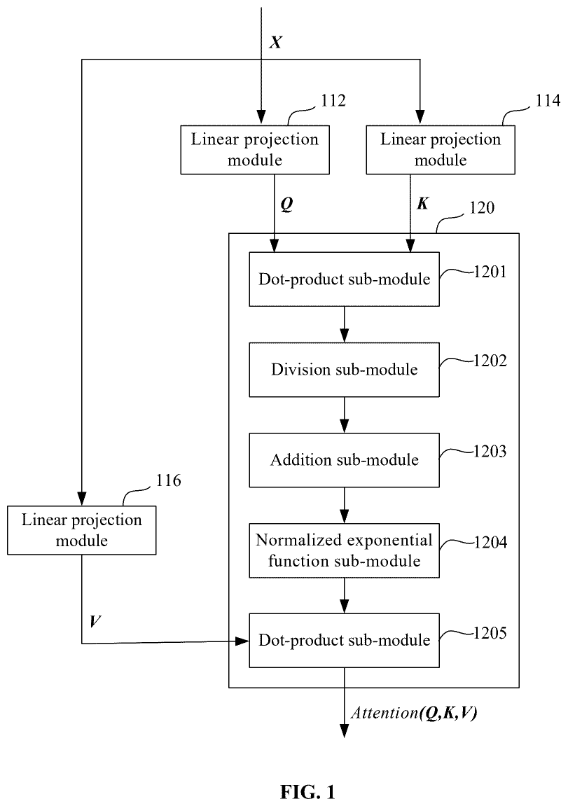

Generally, a transformer model includes two key modules: an encoder and a decoder. The encoder is used to convert an input matrix to a set of intermediate representations, and the decoder is used to convert the intermediate representations to a target sequence. Both the encoder and the decoder include one or more multi-head attention modules, each of which includes a plurality of self-attention modules in parallel. Referring to FIG. 1, a block diagram of a self-attention module is illustrated, in which an attention function is calculated according to the following Equation (1):

$$Attention ( Q , K , V ) = softmax ( \frac{{QK}^{T}}{\sqrt{{d}_{k}}} ) V . \qquad ( 1 )$$

Referring to FIG. 1 and Equation (1), Q, K and V represent a query matrix, a key matrix and a value matrix, respectively. The above three matrices are obtained by linear projections of an input matrix X through linear projection modules 112, 114 and 116, respectively. The input matrix X may be generated based on natural language information, visual image information, etc. A self-attention calculation module 120 first obtains the query matrix Q and the key matrix K, and then calculates a dot-product (or inner product) M of the query matrix Q and a transpose matrix K^{T} of the key matrix K through a dot-product sub-module 1201, i.e., M=QK^{T}. For example, the dot-product sub-module 1201 may calculate the dot-product of the matrix Q and the transpose matrix K^{T} by calling a matmul( ) function. The larger a similarity between the matrix Q and the matrix K^{T} is, the larger the dot-product M is. Accordingly, the dot-product M is also referred to as a similarity or correlation matrix. In order to prevent the correlation matrix M from being too large, the correlation matrix M may be divided by \sqrt{dₖ} through a division sub-module 1202, where dₖ is a dimension of the query matrix Q and/or the key matrix K. The self-attention calculation module 120 may further include an addition sub-module 1203. If the input matrix is large and thus is divided into a plurality of small matrices during the dot-product operation in the dot-product sub-module 1201, the addition sub-module 1203 may add calculation results of the plurality of small matrices to obtain a calculation result of the large matrix. Next, a normalized exponential function (i.e., a softmax function) sub-module 1204 is used to normalize the previous calculation result

$$\frac{{QK}^{T}}{\sqrt{{d}_{k}}}$$

to obtain an attention probability matrix

$$A = softmax ( \frac{Q {K}^{T}}{\sqrt{{d}_{k}}} ) ,$$

each element of which is positive and a sum of all elements of which is 1. At last, a dot-product sub-module 1205 is used to calculate a dot-product of the attention probability matrix A and the value matrix V to obtain a weighted attention matrix

$$Attention ( Q , K , V ) = AV = softmax ( \frac{Q {K}^{T}}{\sqrt{{d}_{k}}} ) V .$$

The inventors of the present application found that although the self-attention module benefits parallel calculating, it suffers from some limitations. For example, both computation time and memory usage of the self-attention module are of [symbol] (n²), where n represents a sequence length of the input matrix X. This means that, if a sequence length n of the input matrix X is doubled, the memory usage will increase to 4 times its original amount, and the computation time will also increase to 4 times its original duration. For example, the sequence length of the GPT-3 model is 2048, and the sequence length of the GPT-4 model is 4096. Then the computational load and memory usage of the GPT-4 model will be four times that of the GPT-3 model.

To reduce GPU memory usage and accelerate computation speed, a method for calculating a self-attention module is provided in embodiments of the present application. In the method, after obtaining a query matrix Q, a key matrix K and a value matrix V used for calculating the self-attention module, at least one of the query matrix Q and the key matrix K is quantized to calculate a quantized correlation matrix M_{q}. Afterwards, the quantized correlation matrix M_{q} is dequantized to obtain a dequantized correlation matrix M_{deq}. Then, the dequantized correlation matrix M_{deq} is processed using the normalized exponential function softmax to obtain an attention probability matrix A. Then, a weighted attention matrix Attention(Q, K, V) of the self-attention module is calculated based on the attention probability matrix A and the unquantized value matrix V. In this method, at least one of the query matrix Q and the key matrix K involved in calculating the correlation matrix M=QK^{T} is quantized, thereby significantly reducing the computational cost of matrix multiplication. In addition, this method fully takes advantage of the property that the processing using the normalized exponential function softmax is insensitive to changes in matrix clement values before and after quantization. That is, even if there are changes in element values between the unquantized correlation matrix M and the quantized correlation matrix M_{q} (or the dequantized correlation matrix M_{deq}), after processing them with the normalized exponential function softmax, the difference between the results is minimal. Therefore, the method can significantly accelerate the calculation of the self-attention module and reduce the memory consumption while incurring minimal loss in computing precision.

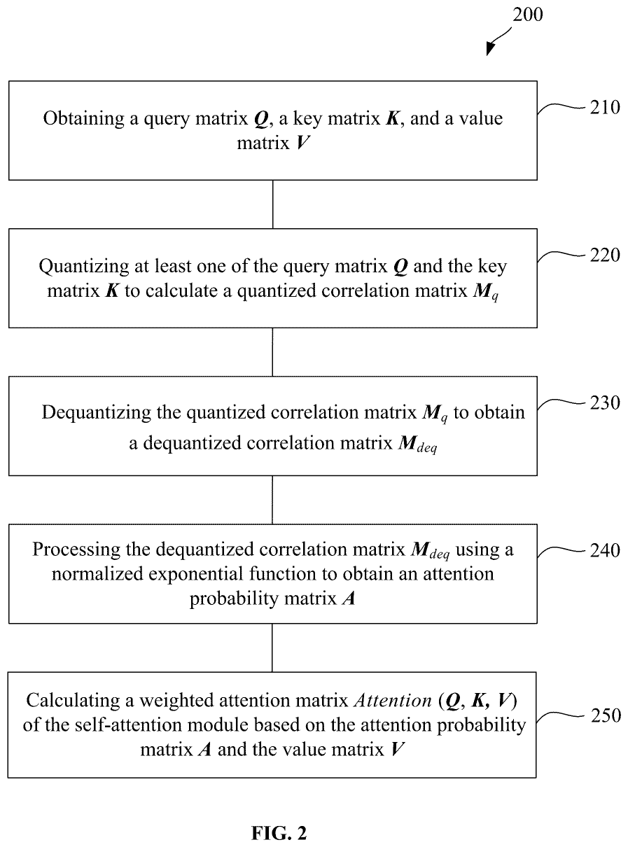

The method for calculating a self-attention module of the present application will be described below in conjunction with the accompanying drawings. FIG. 2 illustrates a flowchart of a method 200 for calculating a self-attention module in a transformer model according to some embodiments of the present application. Specifically, the method 200 may include the following operations 210 to 250.

In the operation 210, a query matrix Q, a key matrix K, and a value matrix V used for calculating the self-attention module are obtained.

Specifically, an input matrix X may be linearly projected using a query weight matrix W^{Q}, a key weight matrix W^{K}, and a value weight matrix W^{V} of the transformer model to generate the query matrix Q, the key matrix K, and the value matrix V, respectively. The query weight matrix W^{Q}, the key weight matrix W^{K}, and the value weight matrix W^{V} may be obtained during a training process of the transformer model.

In some embodiments, the input matrix X may be generated based on an object under processing (such as natural language information, visual image information, etc.). Taking the object under processing as natural language information as an example, word embedding and position embedding operations may be performed on each word or character in the natural language to obtain a word vector representation and a position vector representation of the word or character, respectively. Then, the two representations may be added together to obtain an input vector representation of the word or character. Afterwards, the input vector representations of all words or characters in the natural language information may be combined to obtain the input matrix X of the natural language information for processing by the transformer model.

In some embodiments, when the transformer model includes a plurality of encoders or decoders, the input matrix X of a subsequent encoder or decoder may be derived from the output of a preceding encoder or decoder.

Continuing with the example of the object under processing being natural language information, the input matrix X may be represented as a matrix of (n×dₖ), where n represents the number of words or characters in the input sentence, and dₖ represents the dimension of the vector representation of each word or character. As an example, n may be 12288, and dₖ may be 512, but the scope of the present application is not limited thereto. In the transformer model, the input matrix X is linear projected to obtain three new matrices, namely the query matrix Q, the key matrix K, and the value matrix V, which may increase the number of parameters and improve the inference performance of the transformer model. It should be noted that the query matrix Q, the key matrix K, and the value matrix V have the same matrix size, with each row corresponding to a word or character in the input sentence.

In the operation 220, at least one of the query matrix Q and the key matrix K is quantized to calculate a quantized correlation matrix M_{q}. Quantization refers to the replacement of high bit-width binary numbers with low bit-width binary numbers to represent the elements in a matrix, thereby achieving the effects of accelerating subsequent calculation processes and reducing memory consumption.

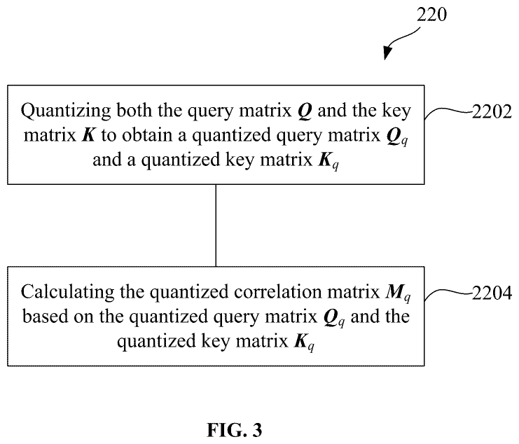

In some embodiments, both the query matrix Q and the key matrix K are quantized in the operation 220 to calculate the quantized correlation matrix M_{q}. Specifically, as shown in FIG. 3, the operation 220 may include sub-operations 2202 and 2204.

In the sub-operation 2202, both the query matrix Q and the key matrix K are quantized to obtain a quantized query matrix Q_{q} and a quantized key matrix K_{q}.

In some embodiments, first, elements in both the query matrix Q and the key matrix K may be truncated (e.g., using a Clip( ) function) to obtain truncated matrices, and then elements in the truncated matrices may be converted from floating-point representation to fixed-point representation (e.g., using a Cast( ) function). The above truncation operation may include: when a value of an element is greater than a predefined maximum value, setting the value of the element to the predefined maximum value; and when the value of the element is less than the predefined minimum value, setting the value of the element to the predefined minimum value. The predefined maximum and minimum values may be determined based on a range of values of the quantized elements.

In an example, the elements of both the query matrix Q and the key matrix K are represented using floating-point numbers (e.g., 32-bit floating-point numbers (fp32)), and after quantization, these elements can be uniformly represented using fixed-point numbers (e.g., 4-bit fixed-point numbers (int4)). A process of quantization operation will be described below, taking the following 3×3 query matrix Q and 3×3 key matrix K as examples,

$$Q = [ \begin{matrix}1.1 , & 1.2 , & 1.3 \\ 2.4 , & 5. , & 10.1 \\ 10. , & - 1.1 , & 0.5\end{matrix} ] ;$$

$$K = [ \begin{matrix}0.2 , & 5.1 , & 0.4 \\ 0.3 , & 10. , & 1.11 \\ 1. , & - 2. , & - 10.\end{matrix} ] .$$

Each element of the 3×3 query matrix Q and 3×3 key matrix K is represented by a 32-bit floating-point number. It could be understood that, the query matrix Q and the key matrix K may have a size much larger than 3×3 in practical applications.

Specifically, a value range is determined to be −8 to 7 based on the quantized element precision (int4). That is, the predefined minimum and maximum values are −8 and 7, respectively. Next, the Clip( ) function is used to truncate the elements in both the query matrix Q and the key matrix K to obtain truncated matrices. For example, the elements 10.1 and 10.0 in the query matrix Q are greater than the predefined maximum value of 7, and these two elements are truncated so that their values are both equal to the predefined maximum value of 7. Similarly, in the key matrix K, the element 10.0 is greater than the predefined maximum value of 7 and the element −10.0 is less than the predefined minimum value of −8. Thus, these two elements are truncated so that their values are equal to the predefined maximum value of 7 and the predefined minimum value of −8, respectively. In addition, the values of other elements in the query matrix Q and the key matrix K are between the predefined minimum value of −8 and the predefined maximum value of 7, and thus remain unchanged, thereby obtaining the truncated matrices. Next, the Cast( ) function is used to convert the data type of the elements in the truncated matrices from the 32-bit floating-point representation to the 4-bit fixed-point representation. The quantization operations performed on both the query matrix Q and the key matrix K described above can be represented by the following Equations (2) and (3), respectively:

$$Q = [ \text{} \begin{matrix}1.1 , & 1.2 , & 1.3 \\ 2.4 , & 5. , & 10.1 \\ 10. , & - 1.1 , & 0.5\end{matrix} ] {⟹}^{Clip} [ \text{} \begin{matrix}1.1 , & 1.2 , & 1.3 \\ 2.4 , & 5. , & 7. \\ 7. , & - 1.1 , & 0.5\end{matrix} ] {⟹}^{Cast} [ \begin{matrix}1 , & 1 , & 1 \\ 2 , & 5 , & 7 \\ 7 , & - 1 , & 0\end{matrix} ] = {Q}_{q} ; \qquad ( 2 )$$

$$K = [ \begin{matrix}0.2 , & 5.1 , & 0.4 \\ 0.3 , & 10. , & 1.11 \\ 1. , & - 2. , & - 10.\end{matrix} ] {⟹}^{Clip} [ \text{} \begin{matrix}0.2 , & 5.1 , & 0.4 \\ 0.3 , & 7. , & 1.11 \\ 1. , & - 2. , & - 8.\end{matrix} ] {⟹}^{Cast} [ \text{} \begin{matrix}0 , & 5 , & 0 \\ 0 , & 7 , & 1 \\ 1 , & - 2 , & - 8\end{matrix} ] = {K}_{q} . \qquad ( 3 )$$

In the above example, the Clip( ) function is used to directly truncate the 32-bit floating-point number to the range of −8 to 7, and then the Cast( ) function is used to convert the data type. Since no extra calculations are needed, the operation is straightforward. However, the present application is not limited to the above quantization method. In other embodiments, the quantization operation on the elements of the query matrix Q and the key matrix K may also be performed using the following Equation (4):

$$r = S ( q - Z ) . \qquad ( 4 )$$

where r represents the value of the element before quantization operation, q represents the value of the element after quantization operation, the constant S represents a compression scale, and the constant Z represents a zero-point value. For example, if the minimum and maximum values of elements in the query matrix Q or the key matrix K are a and b, respectively, and the quantized element value is represented by a 4-bit fixed-point number ranging from −8 to 7, then Z=(b−a)/2 and S=(b−a)/16. In other words, for the specific query matrix Q, key matrix K and quantization precision, the constants S and Z are fixed. After obtaining q through the operation of Equation (4), the elements in the query matrix Q and the key matrix K can be mapped from the values represented by 32-bit floating-point numbers to values ranging from −8 and 7, whose data type are converted to obtain the elements represented by 4-bit fixed-point numbers subsequently.

Then, as shown in FIG. 3, in the sub-operation 2204, the quantized correlation matrix M_{q} is calculated based on the quantized query matrix Q_{q} and the quantized key matrix K_{q}, where

$${M}_{q} = {Q}_{q} {K}_{q}^{T} , and {K}_{q}^{T}$$

is the transpose matrix of the quantized key matrix K_{q}.

Continuing with the above example of the 3×3 quantized query matrix Q_{q} and the 3×3 quantized key matrix K_{q}, the quantized key matrix K_{q} is first transposed to obtain the transpose matrix

$${K}_{q}^{T} :$$

$${K}_{q}^{T} = [ \begin{matrix}0 , & 0 , & 1 \\ 5 , & 7 , & - 2 \\ 0 , & 1 , & - 8\end{matrix} ] .$$

Next, the quantized correlation matrix M_{q} is calculated based on the following Equation (5):

$${M}_{q} = {Q}_{q} {K}_{q}^{T} = [ \begin{matrix}1 , & 1 , & 1 \\ 2 , & 5 , & 7 \\ 7 , & - 1 , & 0\end{matrix} ] \times [ \begin{matrix}0 , & 0 , & 1 \\ 5 , & 7 , & - 2 \\ 0 , & 1 , & - 8\end{matrix} ] = [ \begin{matrix}5 , & 8 , & - 9 \\ 25 , & 42 , & - 64 \\ - 5 , & - 7 , & 9\end{matrix} ] . \qquad ( 5 )$$

It should be noted that, in this example, the quantized correlation matrix M_{q} is obtained by multiplying two matrices represented by 4-bit fixed-point numbers, and the values of its elements may be out of the range [−8,7] represented by the 4-bit fixed-point numbers, requiring higher precision numbers (e.g., 8-bit fixed-point numbers (int8)) to represent them. In other words, the precision of the quantized correlation matrix M_{q} is usually higher than that of the quantized query matrix Q_{q} and the quantized key matrix K_{q}.

As mentioned above, the query matrix Q and the key matrix K usually have a size much larger than 3×3. For example, they may be matrices having a size of 12288×512. Therefore, after quantizing the elements in the query matrix Q and the key matrix K from 32-bit floating-point numbers to 4-bit fixed-point numbers, the calculating of the quantized correlation matrix

$${M}_{q} = {Q}_{q} {K}_{q}^{T}$$

will be much faster than that of the original correlation matrix M=QK^{T}, and the memory consumption will be reduced.

In the above example, the quantization process of the present application was described by taking the quantization of the elements of both the query matrix Q and the key matrix K from 32-bit floating-point numbers to 4-bit fixed-point numbers. However, it may be understood that the elements of the query matrix Q and key matrix K before and after quantization may also be represented by higher or lower bit width numbers, such as octuple-precision floating-point numbers (fp256), quadruple-precision floating-point numbers (fp128), double-precision floating-point numbers (fp64), half-precision floating-point numbers (fp16), 8-bit fixed-point numbers (int8), 6-bit fixed-point numbers (int6), 2-bit fixed-point numbers (int2), 1-bit fixed-point numbers (int1), or any other numbers which are beneficial for accelerating the calculation of self-attention module.

It should be noted that, the calculation acceleration effect and the model accuracy loss resulting from quantizing the query matrix Q and the key matrix K are typically related to the precision of quantization. The elements of the query matrix Q and the key matrix K may be quantized from 32-bit floating-point numbers to 8-bit fixed-point numbers or 4-bit fixed-point numbers. Compared with the quantization from 32-bit floating-point numbers to 8-bit fixed-point numbers, the quantization from 32-bit floating-point numbers to 4-bit fixed-point numbers can accelerate the calculation process of the self-attention module more quickly, but may lead to a greater reduction in model accuracy. Therefore, in practical applications, the appropriate quantization precision can be selected by comprehensively considering both acceleration and accuracy requirements.

The above description, in conjunction with FIG. 3, illustrates the scenario where both the query matrix Q and the key matrix K are quantized simultaneously, but the present application is not limited thereto. In some other embodiments, the query matrix Q may be quantized to obtain a quantized query matrix Q_{q}, and then the quantized correlation matrix M_{q} is calculated based on the quantized query matrix Q_{q} and the key matrix K, where M_{q}=Q_{q}K^{T}. In some other embodiments, the key matrix K may be quantized to obtain a quantized key matrix K_{q}, and then the quantized correlation matrix M_{q} is calculated based on the query matrix Q and the quantized key matrix K_{q}, where

$${M}_{q} = {QK}_{q}^{T} , and {K}_{q}^{T}$$

is the transpose matrix of the quantized key matrix K_{q}. In the above embodiments, the quantization operation performed on the query matrix Q or the key matrix K, and the calculation of the quantized correlation matrix M_{q} are similar to that of the embodiments described above with reference to FIG. 3, and will not be elaborated herein.

Returning to FIG. 2, in the operation 230, the quantized correlation matrix M_{q} is dequantized to obtain a dequantized correlation matrix M_{deq}.

The dequantization operation refers to converting elements in the quantized correlation matrix M_{q} back to their original pre-quantization precision representation. For example, the elements in the quantized correlation matrix M_{q} described above are dequantized from 4-bit fixed-point numbers to 32-bit floating-point numbers, which are consistent with the precision of the query matrix Q and the key matrix K before quantization.

Specifically, the process of dequantizing the quantized correlation matrix M_{q} in the above Equation (5) to obtain the dequantized correlation matrix M_{deq} may be represented by the following Equation (6):

$${M}_{q} = [ \begin{matrix}5 , & 8 , & - 9 \\ 25 , & 42 , & - 64 \\ - 5 , & - 7 , & 9\end{matrix} ] {⟹}^{dequantization} [ \begin{matrix}5. , & 8. , & - 9. \\ 25. , & 42. , & - 64. \\ - 5. , & - 7. , & 9.\end{matrix} ] = {M}_{deq} . \qquad ( 6 )$$

Next, in the operation 240, a normalized exponential function is used to process the dequantized correlation matrix M_{deq} to obtain an attention probability matrix A.

The normalized exponential function, also known as the Softmax function, may be expressed as the following Equation (7):

$$Softmax ( {x}_{n} ) = \frac{{e}^{{x}_{n}}}{{\sum }_{n = I}^{N} {e}^{{x}_{n}}} ; \qquad ( 7 )$$

where xₙ represents the n^{th} element in a matrix, N represents the number of elements in the matrix, and Softmax(xₙ) represents a result of processing the n^{th} element xₙ. The normalized exponential function Softmax can convert all elements in the matrix into values within the range of [0,1], and their sum is 1.

In some embodiments, before using the normalized exponential function to process the dequantized correlation matrix M_{deq}, it is also necessary to obtain a dimension parameter dₖ of the key matrix K (or the query matrix Q), for example, dₖ=512 as mentioned above. Next, the normalized exponential function Softmax is used to process the dequantized correlation matrix M_{deq} scaled based on the dimension parameter dₖ to obtain the attention probability matrix A. Scaling the dequantized correlation matrix M_{deq} using the dimension parameter dₖ can prevent the dequantized correlation matrix M_{deq} from being too large, which is beneficial for obtaining a stable attention probability gradient. A calculation process of the attention probability matrix A can be represented by the following Equation (8):

$$A = softmax ( \frac{{M}_{d e q}}{\sqrt{{d}_{k}}} ) ; \qquad ( 8 )$$

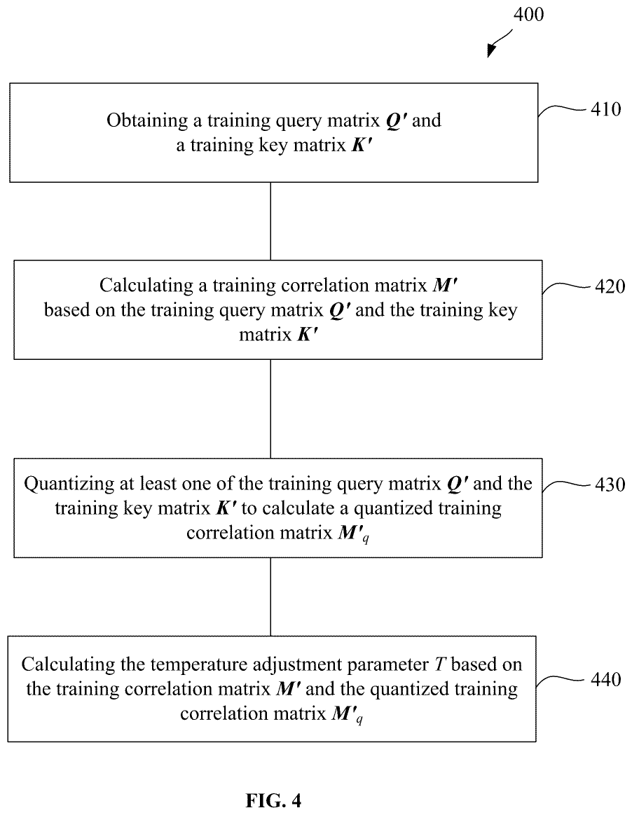

In some embodiments, considering that the elements in the query matrix Q and the key matrix K that exceed the quantization range were directly truncated using the Clip( ) function in the previous quantization process, this may lead to a flattened parameter distribution (i.e., reduced sharpness) in the attention probability matrix A obtained by processing the dequantized correlation matrix M_{deq} with the normalized exponential function. Therefore, when calculating the attention probability matrix A, the technical solution of the present invention further introduces a temperature adjustment parameter T to improve the sharpness of the parameter distribution in the attention probability matrix A. The temperature adjustment parameter T may be obtained as a constant through offline training on a preset dataset and can be directly used during the online inference phase. A method for obtaining the adjustment parameter T will be described in detail below in conjunction with FIG. 4. As an example, the value of the adjustment parameter T may be 1.03, but the technical solution of the present application is not limited thereto, and the value of the adjustment parameter T may vary depending on specific characteristics of the transformer model and application scenarios. When calculating the attention probability matrix A, the dimension parameter dk and the temperature adjustment parameter T may be used to scale the dequantized correlation matrix M_{deq} first, and then the normalized exponential function Softmax may be used to process the scaled result. Specifically, in these embodiments, the calculation process of the attention probability matrix A may be represented by the following Equation (9):

$$A = softmax ( \frac{{M}_{d e q}}{T \sqrt{{d}_{k}}} ) . \qquad ( 9 )$$

Continuing with the example of the dequantized correlation matrix M_{deq} in Equation (6) above, in order to simplify the calculation, the value of T\sqrt{dₖ} is set to 1 here. Then the calculation result of Equation (9) can be expressed as:

$$A = [ \begin{matrix}8.53 \; 304727 \times {10}^{- 17} , & 1.71 \; 390836 \times {10}^{- 15} , & 7.0954 \; 7387 \times 1 {0}^{- 23} \\ 4.13 \; 993755 \times {10}^{- 8} , & 9.99 \; 999959 \times {10}^{- 1} , & 9.2211 \; 4604 \times 1 {0}^{- 47} \\ 3.87 \; 399747 \times {10}^{- 21} , & 5.24 \; 288545 \times {10}^{- 22} , & 4.6588 \; 8595 \times 1 {0}^{- 15}\end{matrix} ] .$$

For comparison, when the query matrix Q and the key matrix K are not quantized, the correlation matrix may be calculated as:

$$M = {QK}^{T} = [ \begin{matrix}1.1 , & 1.2 , & 1.3 \\ 2.4 , & 5. , & 10.1 \\ 10. , & - 1.1 , & 0.5\end{matrix} ] \times [ \begin{matrix}0.2 , & 0.3 , & 1. \\ 5.1 , & 10. , & - 2. \\ 0.4 , & 1.11 , & - 10.\end{matrix} ] = [ \begin{matrix}6.86 , & 13.773 , & - 14.3 \\ 30.02 , & 61.931 , & - 108.6 \\ - 3.41 , & - 7.445 , & 7.2\end{matrix} ] .$$

Next, the normalized exponential function is further used to process the correlation matrix M to obtain the attention probability matrix A:

$$A = softmax ( \frac{{M}_{d e q}}{\sqrt{{d}_{k}}} ) = [ \begin{matrix}1.21051057 \times {10}^{- 24} , & 1.21687604 \times {10}^{- 21} , & 7.82163148 \times {10}^{- 34} \\ 1.38429544 \times {10}^{- 14} , & 1. \times {10}^{0} , & 8.6961637 \times {10}^{- 75} \\ 4.19531194 \times {10}^{- 29} , & 7.41969449 \times {10}^{- 31} , & 1.70070391 \times {10}^{- 24}\end{matrix} ] .$$

By comparing the attention probability matrices A obtained with and without the quantization operations, it can be seen that the parameter distributions of the two matrices are very close. This further validates that the normalized exponential function softmax exhibits insensitivity to value variations caused by quantization in matrix elements. Consequently, the quantization of the query matrix Q and the key matrix K does not significantly reduce the accuracy of the transformer model.

Finally, in the operation 250, a weighted attention matrix Attention(Q, K, V) of the self-attention module is calculated based on the attention probability matrix A and the value matrix V.

Specifically, a process of calculating the weighted attention matrix Attention(Q, K, V) of the self-attention module based on the attention probability matrix A and the value matrix V may be represented by the following Equation (10):

$$Attention ( Q , K , V ) = softmax ( \frac{{M}_{d e q}}{T \sqrt{{d}_{k}}} ) V . \qquad ( 10 )$$

As mentioned above, the elements of the attention probability matrix A are all within the range of [0,1], and their sum is 1. After multiplying it with the value matrix V, it is equivalent to assigning different weights to the elements of the value matrix V, thereby obtaining a weighted attention matrix Attention(Q, K, V). The weighted attention matrix Attention(Q, K, V) may be used for further calculations of the transformer model. For example, weighted attention matrices Attention(Q, K, V) generated by all self-attention modules in a multi-head attention module, which includes the present self-attention module, may be combined for the next level calculation, which will not be elaborated herein.

FIG. 4 illustrates a flowchart of a method 400 for calculating a temperature adjustment parameter T according to embodiments of the present application. The method 400 may be implemented in the offline training process of the transformer model. It uses both non-quantization and quantization schemes in the calculation process of the self-attention module to calculate an unquantized correlation matrix M and a quantized correlation matrix M_{q} respectively, and then calculates the temperature adjustment parameter T based on the unquantized correlation matrix M and the quantized correlation matrix M_{q}.

Specifically, first, a training input matrix X′ is obtained from a preset dataset for offline training, and then linear projections are performed on the training input matrix X′ to generate a training query matrix Q′ and a training key matrix K′ (Operation 410). Then, a training correlation matrix M′ is calculated based on the training query matrix Q′ and the training key matrix K′, where M′=Q′K′^{T} (Operation 420). At least one of the training query matrix Q′ and the training key matrix K′ is quantized to calculate a quantized training correlation matrix M′_{q} (Operation 430), where

$${M}_{q}^{′} = {Q}_{q}^{′} {K}_{q}^{′ T}$$

or Q′_{q}K′^{T} or

$${Q}^{′} {K}_{q}^{′ T} ,$$

Q′_{q} represents a matrix generated by quantizing the training query matrix Q′, and K′_{q} represents a matrix generated by quantizing the training key matrix K′. It could be understood that there is no specific execution order for Operation 420 and Operation 430, and they may be executed sequentially or simultaneously. In Operation 440, a temperature adjustment parameter T is calculated based on the obtained training correlation matrix M′ and quantized training correlation matrix M′_{q}. For example, the temperature adjustment parameter T may be determined by calculating a ratio of the training correlation M′ matrix M′ to the quantized training correlation matrix M′_{q}, i.e.,

$$T = \frac{{M}^{′}}{{M}_{q}^{′}} .$$

It should be noted that the preset dataset may include multiple training data, each of which may form a training input matrix X′. Therefore, for different training input matrices X′ obtained from the preset dataset, the method 400 may generate different temperature adjustment parameters T. In some embodiments, the method 400 may be used to calculate respective temperature adjustment parameters T based on the multiple training input matrices X′, and then an average value of these temperature adjustment parameters T may be calculated as a final temperature regulation parameter. In some embodiments, the average value of the temperature adjustment parameters T may be obtained by calling a mean( ) function. The final temperature adjustment parameter mentioned above may be stored in the transformer model. When this transformer model is used for online inference, the temperature adjustment parameter can be directly used to the method 200 described above to accelerate the calculation of the self-attention module of the transformer model.

The inventors of the present application used the GPT-3 model as an example to verify the effectiveness of the method for accelerating the calculation of the self-attention modules in the present application. For example, during the inference process of the GPT-3 model, it is required to store the calculated values of the key matrix K and the value matrix V, and the memory consumption is approximately 4×2×B×96×2048×12288, where “4” indicates that each fp32 data occupies 4 bytes, “2” indicates the key matrix K and the value matrix V, “B” represents a batch size, “96” indicates a number of layers of the GPT-3 model, “2048” indicates a sequence length, and “12288” indicates a vector length. In the case of B=16, the memory required to store the calculated values of the key matrix K and the value matrix V is about 228G. However, by using the solution of the present application to accelerate the inference process of the GPT-3 model, the memory required to store the calculated values of the key matrix K and the value matrix V is reduced to 162G. Further, in the solution of the present application, the matrix Q and the matrix K may be quantized into 4-bit fixed-point numbers, so that the calculation of M=QK^{T} may be performed using an 8-bit fixed-point number calculation unit (int8 TCore) (or a 4-bit fixed-point number calculation unit (int4 TCore)). Generally, the operation speed of the int8 TCore (or int4 TCore) is 4 (or 8) times that of the 32-bit floating-point number calculation unit (fp 32 TCore) for hardware. In addition, after quantization (such as int8 or int4 quantization), the bandwidth of graphic memory (such as HBM, High Bandwidth Memory) can be utilized more efficiently, thus achieving an acceleration effect of 1.95 times for the entire calculation process of Attention(Q, K, V).

In addition, the inventors of the present invention also compared the method for accelerating the calculation of self-attention modules in the present application with other conventional acceleration methods.

Specifically, referring to Table 1, based on the Squad dataset of the BERT model, a multi-dimensional comparison between the quantization acceleration method of the present application and the conventional calculation acceleration methods is shown. As shown in Table 1, the second to fifth rows respectively show the cases of an un-accelerated BERT model with 32-bit floating-point precision, a conventional method of quantizing the linear projection process of QKV in the BERT model with 8-bit fixed-point numbers, a conventional method of sparsifying the self-attention module of the BERT model, and a method of accelerating the BERT model using the technical solution of the present application, in terms of model accuracy, model compression ratio, performance under memory bound, and performance under compute bound.

TABLE 1
Comparison between the method of this
application and conventional methods

| | | | Performance | Performance |
|---|---|---|---|---|
| | F1 | | under | under |
| | score | Compression | memory | compute |
| | (%) | ratio (%) | bound | bound |
| BERT, tf32 | 81.725 | 1 | 1 | 1 |
| BERT, int8 | 71.030 | 0.350 | 4 | 1 |
| quantization | | | | |
| BERT, | — | 0.695 | 1 | 4 |
| Sparsification | | | | |
| Quantization | 81.012 | 0.431 | 3.23 | 1.95 |
| method of this | | | | |
| application | | | | |

Referring to the F1 scores representing the model accuracies in the second column of Table 1, as the baseline for comparison, the F1 score of the BERT model with tf32 (Tensor Float 32) precision is 81.725. After int8 quantization of the linear projection process of QKV in the BERT model, its F1 score is 71.030, and quantization aware training (QAT) is required. After sparsification of the self-attention module of the BERT model, its accuracy is almost completely lost, and retraining is required. On the other hand, by using the technical solution of the present application and performing int4 quantization on the matrix Q and the matrix K without performing quantization on the matrix V, the F1 score is 81.012, which is only slightly lower than the comparison baseline, thereby effectively preserving the model accuracy. Referring to the compression ratios in the third column of Table 1, the compression ratio of the technical solution of the present application is 0.431, which is higher than the compression ratio (i.e., 0.350) of the int8 quantization scheme for the linear projection process of QKV in the BERT model, but lower than the compression ratio (i.e., 0.695) of the sparsification scheme for the self-attention module of the BERT model. Referring to the performance parameters under memory bound in the fourth column of Table 1, it can be seen that, when the BERT model is in a memory bound state, its performance is related to the model size. The performance parameter of the technical solution of the present application (i.e., 3.23) is lower than the performance parameter (i.e., 4) of the int8 quantization scheme for the linear projection process of QKV in the BERT model, but is higher than the performance parameter (i.e., 1) of the sparsification scheme for the self-attention module of the BERT model. Continuing to refer to the performance parameters under the compute bound in the fifth column of Table 1, the performance parameter of the technical solution of the present application (i.e., 1.95) is lower than the performance parameter (i.e., 4) of the sparsification scheme for the self-attention module of the BERT model, but is higher than the performance parameter (i.e., 1) of the int8 quantization scheme for the linear projection process of QKV in the BERT model, because the int8 quantization scheme involves fp32 to int8 conversion, which takes a certain amount of time, while the method of the present application may directly perform clip-operations on matrix elements without additional operations. In summary, the technical solution of the present application may achieve better and comprehensive advantages in terms of model accuracy, model compression ratio, and performance under memory bound and compute bound. While improving performance, it can also preserve accuracy without introducing additional training processes.

It should be noted that, in the comparison of Table 1, the method for calculating the self-attention module of the present application was described by quantizing both the matrix Q and the matrix K, but the technical solution of the present application is not limited thereto. As mentioned earlier, in other embodiments, it is also possible to only quantize the matrix Q to obtain the quantized matrix Q_{q}; and afterwards, the correlation matrix M is calculated based on the quantized matrix Q_{q} and the unquantized matrix K. In some other embodiments, only the matrix K may be quantized to obtain the quantized matrix K_{q}; and afterwards, the correlation matrix M is calculated based on the quantized matrix K_{q} and the unquantized matrix Q. Referring to Table 2 below, a comparison of model accuracies represented by F1 scores is shown under different quantization schemes mentioned above.

As shown in Table 2, the second row shows the F1 score of the BERT model with tf32 precision without acceleration. The third to fifth rows respectively show the F1 scores in the cases of quantizing the matrix Q and the matrix K, quantizing only the matrix K, and quantizing only the matrix Q of the BERT model using the technical solution of the present application. It can be seen that, compared to the baseline of the BERT model with tf32 precision, the F1 score of quantizing both the matrix Q and the matrix K decreases by only about 0.713%; the F1 score of only quantizing the matrix K decreases by approximately 0.451%; and the F1 score of only quantizing the matrix Q decreases by approximately 0.158%, which indicates that the technical solution of the present application is highly feasible under different quantization schemes

TABLE 2
Comparison between the method of this
application and conventional methods

| | F1 score |
|---|---|
| | (%) |
| BERT, tf32 | 81.725 |
| BERT, int4 quantization of Q and K | 81.012 |
| BERT, int4 quantization of K | 81.274 |
| BERT, int4 quantization of Q | 81.567 |

According to another aspect of the present application, a method for inferring input information is provided. The method includes: obtaining input information and a neural network model, wherein the input information includes or is generated based on natural language information or visual image information, and the neural network model includes a self-attention module; obtaining a query matrix Q, a key matrix K, and a value matrix V for calculating a self-attention module based on the input information; calculating a weighted attention matrix Attention(Q, K, V) of the self-attention module using the aforementioned calculation method 200; and using the weighted attention matrix Attention(Q, K, V) in the process of inferring the input information using the neural network model. More details about the method 200 for calculating the self-attention module can be referred to the previous description, and will not be elaborated herein.

According to another aspect of the present application, an electronic device is provided. The electronic device is capable of performing the method for calculating the self-attention module provided in the aforementioned embodiments, and thus can perform corresponding processes on natural language information, visual image information, and the like.

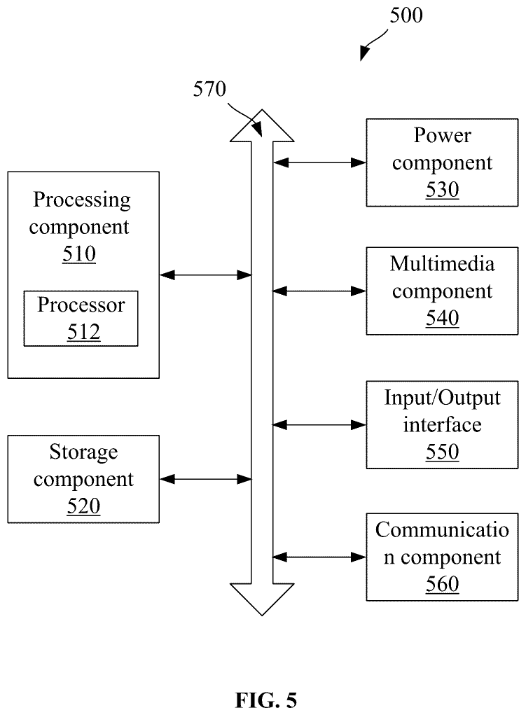

Referring to FIG. 5, a structural block diagram of an electronic device 500 is illustrated according to an embodiment of the present application. The electronic device 500 may be, for example, an artificial intelligence (AI) computing device, a cloud computing device, a personal computer, a mobile computing device, etc.

As shown in FIG. 5, the electronic device 500 includes a processing component 510 and a storage component 520. The processing component 510 is usually used to control the overall operation of the electronic device 500, and may include one or more processors 512. The processor 512 is capable of executing instructions to complete all or part of the steps of the aforementioned method for calculating the self-attention module. As an example, the processor 512 may include one or more of a graphics processing unit (GPU), a central processing unit (CPU), a digital signal processor (DSP), or other processors. The storage component 520 is configured to store different types of data to support the operation of the electronic device 500, including but not limited to: instructions for any application or method operating on the electronic device 500, or related data, files, images, videos, etc. For example, the storage component 520 may store a computer program that, when executed by the processing component 510, may implement all or part of the steps of the aforementioned method for calculating the self-attention module. The storage component 520 may be implemented by any type of volatile or non-volatile storage device or combination thereof. For example, the storage component 520 may include one or more of a static random access memory, a dynamic random access memory, a magnetic storage, a flash memory, or an optical disc.

In the example of FIG. 5, the electronic device 500 further includes a power component 530, a multimedia component 540, an input/output interface 550, and a communication component 560. The power component 530 may provide power to various components of the electronic device 500; the multimedia component 540 may provide multimedia interaction for a user of the electronic device 500, such as a screen, an audio device, a camera, etc.; the input/output interface 550 may provide an interactive interface between the electronic device 500 and the user; and the communication component 560 is configured to facilitate wired or wireless communication between the electronic device 500 and other devices. The processing component 510, the storage component 520, the power component 530, the multimedia component 540, the input/output interface 550, and the communication component 560 may be selectively electrically connected directly or indirectly through another communication component 570 (e.g., various buses, communication interfaces, etc.) to achieve the transmission or interaction of data or instructions. However, the electronic device of the present application is not limited to this example, and may include more or fewer components.

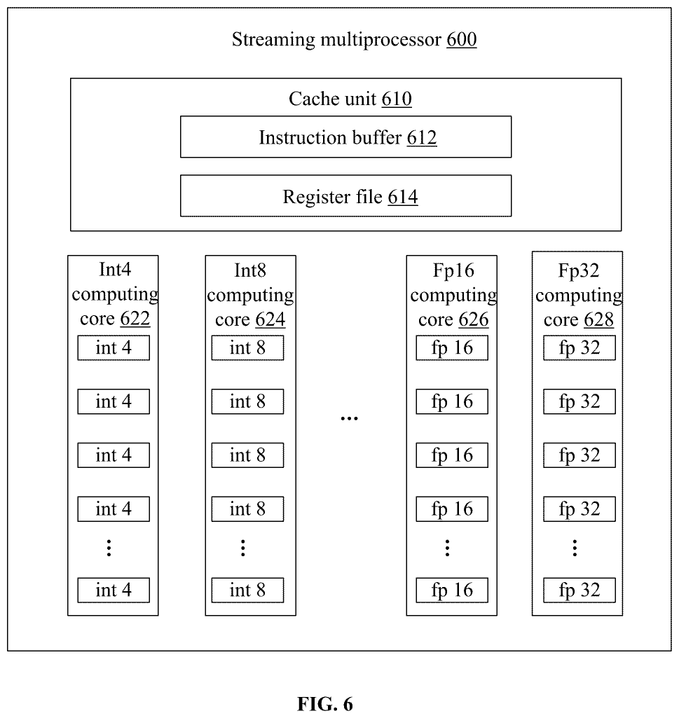

In the following, a process of the electronic device 500 performing the method for calculating the self-attention module is further described by taking the processor 512 in FIG. 5 being a GPU as an example. The GPU usually includes a plurality of parallel streaming multiprocessors, which may process multiple tasks simultaneously through parallel calculating, making it more suitable for the calculation of the transformer model. Referring to FIG. 6, a structural block diagram of an example streaming multiprocessor 600 is illustrated, which may be a part of the GPU 512 shown in FIG. 5, for example. The streaming multiprocessor 600 includes a cache unit 610 and a plurality of computing cores with different computing precisions, such as one or more int4 computing cores 622, one or more int8 computing cores 624, one or more fp16 computing cores 626, one or more fp32 computing cores 628, etc. However, the present application is not limited to the example shown in FIG. 6. The streaming multiprocessor may have more, fewer, or other computing cores with different computation precisions, such as computing cores with bf16 (brain float 16), tf32, fp64, and other computation precisions.

Referring to both FIG. 5 and FIG. 6, the processing component 510 obtains a computer program from the storage component 520. When the computer program is executed by the processing component 510, for example, by the streaming multiprocessor 600 in the GPU 512, all or part of the steps of the method for calculating the self-attention module in the aforementioned embodiments may be implemented. The streaming multiprocessor 600 may store instructions related to the method in an instruction buffer 612 of the cache unit 610, and store data related to the method (such as parameter data of the transformer model, natural language data or visual image data to be processed, etc.) in a register file 614 of the cache unit 610.

Firstly, the streaming multiprocessor 600 obtains a query matrix Q, a key matrix K, and a value matrix V for calculating the self-attention module, and quantizes the query matrix Q and the key matrix K to obtain a quantized query matrix Q_{q} and a quantized key matrix K_{q}. For example, elements of the query matrix Q and the key matrix K are represented by 32-bit floating-point numbers (fp32), and after quantization, elements of the quantized query matrix Q_{q} and the quantized key matrix K_{q} are represented by 4-bit fixed-point numbers (int4).

It should be noted that, during the processing, the streaming multiprocessor 600 may store the key matrix K in the register file 614, and read it from the register file 614 when in use. Assuming that hardware instructions of the streaming multiprocessor 600 (or the GPU 512) can store (or read) 128 bytes at a time, then within one instruction cycle, the streaming multiprocessor 600 can store (or read) 32 fp32 data (e.g., the unquantized key matrix K), or can store (or read) 256 int4 data (e.g., the quantized key matrix K_{q}). Therefore, in embodiments of the present application, quantizing the key matrix K, and then storing or reading the quantized key matrix K_{q} can significantly reduce consumption of the storage space in the streaming multiprocessor 600 and improve efficiency of reading data, thereby increasing the model calculation density ratio and accelerating the model calculation speed. The above description takes the key feature matrix K as an example to illustrate the storing and reading of data in the streaming multiprocessor 600, but the present application is not limited thereto. In other embodiments, the query matrix Q, both the query matrix Q and the key matrix K, or other calculation data may also be stored and read.

Next, the streaming multiprocessor 600 calculates a quantized correlation matrix M_{q} based on the quantized query matrix Q_{q} and the quantized key matrix K_{q}. In an example, the streaming multiprocessor 600 may select a computing core from the plurality of computing cores with different computing precisions, where a computing precision of the selected computing core corresponds to a precision of elements in the quantized query matrix Q_{q} and the quantized key matrix K_{q}, and then use the selected computing core to calculate the quantized correlation matrix M_{q}.

The calculation process continues to be described with the example where the elements of the query matrix Q and the key matrix K are fp32 data, and the quantized query matrix Q_{q} and quantized key matrix K_{q} are int4 data. A multiplication operation of the query matrix Q and the key matrix K may need the fp32 computing core (e.g., fp32 tensor core) 628. However, after quantization, the int4 computing core 622 (or the int8 computing core 624) may be selected from the plurality of computing cores with different computing precisions to calculate the quantized correlation matrix M_{q} based on the quantized query matrix Q_{q} and the quantized key matrix K_{q}. Compared with using the fp32 computing core 628, using the int4 computing core 622 to calculate the correlation matrix can significantly improve the calculation speed, for example, by about 8 times. It should be noted that, the streaming multiprocessor 600 may only include a limited number of types of computing cores with different computing precisions. For example, the streaming multiprocessor 600 may not have the int4 computing core 622. Then, when selecting a computing core, which has a computing precision corresponds to the precision of the elements after quantization, from the plurality of computing cores with different computing precisions, a computing core with the similar computing precision may be chosen, such as the int8 computing core 624, which can also improve the calculation speed, for example, by about 4 times.

Subsequently, the streaming multiprocessor 600 may dequantize the quantized correlation matrix M_{q} to obtain a dequantized correlation matrix M_{deq}, process the dequantized correlation matrix M_{deq} using a normalized exponential function to obtain an attention probability matrix A; and calculate the weighted attention matrix Attention(Q, K, V) of the self-attention module based on the attention probability matrix A and the value matrix V. The specific processing procedure and related modifications may refer to the description of the method 200 for calculating the self-attention module in the previous descriptions, which will not be elaborated here.

A non-volatile computer-readable storage medium is also provided according embodiments of the present application. A computer program may be stored on the non-volatile computer-readable storage medium. When the computer program is executed by a processor, the method 200 for calculating the self-attention module or the method 400 for calculating a temperature adjustment parameter T described in the above embodiments can be performed. In some embodiments, the non-volatile computer-readable storage medium may include a flash memory, a read-only memory (ROM), an electrically programmable ROM, an electrically erasable programmable ROM, a register, a hard disk, a removable disk, a CD-ROM, or any other form of non-volatile computer-readable storage medium known in this technical field.

Those skilled in the art will be able to understand and implement other changes to the disclosed embodiments by studying the specification, disclosure, drawings and appended claims. In the claims, the wordings “comprise”, “comprising”, “include” and “including” do not exclude other elements and steps, and the wordings “a” and “an” do not exclude the plural. In the practical application of the present application, one component may perform the functions of a plurality of technical features cited in the claims. Any reference numeral in the claims should not be construed as limit to the scope.

1. A method for calculating a self-attention module, comprising:
obtaining a query matrix Q, a key matrix K, and a value matrix V for calculating the self-attention module;
quantizing at least one of the query matrix Q and the key matrix K to calculate a quantized correlation matrix M_{q};
dequantizing the quantized correlation matrix M_{q} to obtain a dequantized correlation matrix M_{deq};
processing the dequantized correlation matrix M_{deq} using a normalized exponential function to obtain an attention probability matrix A; and
calculating a weighted attention matrix Attention(Q, K, V) of the self-attention module based on the attention probability matrix A and the value matrix V.

2. The method of claim 1, wherein obtaining the query matrix Q, the key matrix K, and the value matrix V for calculating the self-attention module comprises:
performing linear projection operations on an input matrix X using a query weight matrix W^{Q}, a key weight matrix W^{K} and a value weight matrix W^{V} to generate the query matrix Q, the key matrix K and the value matrix V, respectively.

3. The method of claim 2, wherein the input matrix X is generated based on natural language information or visual image information.

4. The method of claim 1, wherein quantizing at least one of the query matrix Q and the key matrix K to calculate the quantized correlation matrix M_{q} comprises:
quantizing both the query matrix Q and the key matrix K to obtain a quantized query matrix Q_{q} and a quantized key matrix K_{q}; and
calculating the quantized correlation matrix M_{q} based on the quantized query matrix Q_{q} and the quantized key matrix K_{q}, wherein
$${M}_{q} = {Q}_{q} {K}_{q}^{T} , and {K}_{q}^{T}$$
is a transpose matrix of the quantized key matrix K_{q}.

5. The method of claim 1, wherein quantizing at least one of the query matrix Q and the key matrix K to calculate the quantized correlation matrix M_{q} comprises:
quantizing the query matrix Q to obtain a quantized query matrix Q_{q}; and
calculating the quantized correlation matrix M_{q} based on the quantized query matrix Q_{q} and the key matrix K, where M_{q}=Q_{q}K^{T}, and K^{T} is a transpose matrix of the key matrix K.

6. The method of claim 1, wherein quantizing at least one of the query matrix Q and the key matrix K to calculate the quantized correlation matrix M_{q} comprises:
quantizing the key matrix K to obtain a quantized key matrix K_{q}; and
calculating the quantized correlation matrix M_{q} based on the query matrix Q and the quantized key matrix K_{q}, where
$${M}_{q} = Q {K}_{q}^{T} , and {K}_{q}^{T}$$
is a transpose matrix of the quantized key matrix K_{q}.

7. The method of claim 1, wherein the query matrix Q and the key matrix K employ a floating-point representation; and
wherein quantizing at least one of the query matrix Q and the key matrix K comprises:
converting the at least one of the query matrix Q and the key matrix K from the floating-point representation to a fixed-point representation.

8. The method of claim 7, wherein converting the at least one of the query matrix Q and the key matrix K from the floating-point representation to the fixed-point representation comprises:
truncating each element of the at least one of the query matrix Q and the key matrix K to obtain a truncated matrix, wherein the truncating comprises:
when a value of the element is greater than a predefined maximum value, setting the value of the element equal to the predefined maximum value; and
when a value of the element is less than a predefined minimum value, setting the value of the element equal to the predefined minimum value; and
converting the truncated matrix from the floating-point representation to the fixed-point representation.

9. The method of claim 7, wherein the query matrix Q and the key matrix K are represented by 32-bit floating-point numbers, and the at least one of the query matrix Q and the key matrix K is quantized to be represented by 4-bit fixed-point numbers.

10. The method of claim 1, wherein processing the dequantized correlation matrix M_{deq} using the normalized exponential function to obtain the attention probability matrix A comprises:
obtaining a dimension parameter dₖ of the query matrix Q or the key matrix K; and
processing the dequantized correlation matrix M_{deq} scaled based on the dimension parameter dₖ using the normalized exponential function to obtain the attention probability matrix A, wherein
$$A = softmax ( \frac{{M}_{d e q}}{\sqrt{{d}_{k}}} ) ,$$
and softmax represents the normalized exponential function.

11. The method of claim 10, wherein processing the dequantized correlation matrix M_{deq} scaled based on the dimension parameter dₖ using the normalized exponential function to obtain the attention probability matrix A comprises:
processing the dequantized correlation matrix M_{deq} scaled based on the dimension parameters dₖ and a temperature adjustment parameter T using the normalized exponential function to obtain the attention probability matrix A, wherein
$$A = softmax ( \frac{{M}_{d e q}}{T \sqrt{{d}_{k}}} ) .$$

12. The method of claim 11, further comprising:
obtaining a training input matrix X′ from a preset dataset;
performing linear projections on the training input matrix X′ to generate a training query matrix Q′ and a training key matrix K′;
calculating a training correlation matrix M′ based on the training query matrix Q′ and the training key matrix K′;
quantizing at least one of the training query matrix Q′ and the training key matrix K′ to calculate a quantized training correlation matrix M′_{q}; and
calculating the temperature adjustment parameter T based on the training correlation matrix M′ and the quantized training correlation matrix M′_{q}.

13. A method for inferring input information, comprising:
obtaining the input information and a neural network model, wherein the input information is generated based on natural language information or visual image information, and the neural network model comprises a self-attention module;
obtaining a query matrix Q, a key matrix K, and a value matrix V for calculating the self-attention module based on the input information;
calculating the weighted attention matrix Attention(Q, K, V) of the self-attention module according to the method of claim 1; and
using the weighted attention matrix Attention(Q, K, V) in a process of inferring the input information using the neural network model.

14. An electronic device, comprising:
a processing component comprising a plurality of computing cores with different computing precisions; and
a storage component configured for storing a computer program executable by the processing component, wherein, when the computer program is executed by the processing component, the processing component is caused to perform:
obtaining a query matrix Q, a key matrix K, and a value matrix V for calculating a self-attention module;
quantizing the query matrix Q and/or the key matrix K to obtain a quantized query matrix Q_{q} and/or a quantized key matrix K_{q};
selecting a computing core from the plurality of computing cores with different computing precisions, wherein a computing precision of the selected computing core corresponds to a precision of elements in the quantized query matrix Q_{q} and/or the quantized key matrix K_{q};
controlling the selected computing core to calculate a quantized correlation matrix M_{q} based on the quantized query matrix Q_{q} and/or the quantized key matrix K_{q};
dequantizing the quantized correlation matrix M_{q} to obtain a dequantized correlation matrix M_{deq};
processing the dequantized correlation matrix M_{deq} using a normalized exponential function to obtain an attention probability matrix A; and
calculating a weighted attention matrix Attention(Q, K, V) of the self-attention module based on the attention probability matrix A and the value matrix V.

15. The electronic device of claim 14, wherein the processing component further comprises a cache unit, and the processing component is further caused to perform:
storing the quantized query matrix Q_{q} and/or the quantized key matrix K_{q} in the cache unit; and/or
reading the quantized query matrix Q_{q} and/or the quantized key matrix K_{q} from the cache unit.

16. The electronic device of claim 14, wherein obtaining the query matrix Q, the key matrix K, and the value matrix V for calculating the self-attention module comprises:
performing linear projection operations on an input matrix X using a query weight matrix W^{Q}, a key weight matrix W^{K} and a value weight matrix W^{V} to generate the query matrix Q, the key matrix K and the value matrix V, respectively, wherein the input matrix X is generated based on natural language information or visual image information.

17. The electronic device of claim 14, wherein the query matrix Q and the key matrix K employ a floating-point representation; and
wherein quantizing the query matrix Q and/or the key matrix K to obtain the quantized query matrix Q_{q} and/or the quantized key matrix K_{q} comprises:
converting the query matrix Q and/or the key matrix K from the floating-point representation to a fixed-point representation to obtain the quantized query matrix Q_{q} and/or the quantized key matrix K_{q}.

18. The electronic device of claim 14, wherein processing the dequantized correlation matrix M_{deq} using the normalized exponential function to obtain the attention probability matrix A comprises:
obtaining a dimension parameter dₖ of the query matrix Q or the key matrix K; and
processing the dequantized correlation matrix M_{deq} scaled based on the dimension parameter dₖ using the normalized exponential function to obtain the attention probability matrix A, wherein
$$A = softmax ( \frac{{M}_{d e q}}{\sqrt{{d}_{k}}} ) ,$$
and softmax represents the normalized exponential function.

19. The electronic device of claim 18, wherein processing the dequantized correlation matrix M_{deq} scaled based on the dimension parameter dₖ using the normalized exponential function to obtain the attention probability matrix A comprises:
processing the dequantized correlation matrix M_{deq} scaled based on the dimension parameters dₖ and a temperature adjustment parameter T using the normalized exponential function to obtain the attention probability matrix A, wherein
$$A = softmax ( \frac{{M}_{d e q}}{T \sqrt{{d}_{k}}} ) .$$

20. The electronic device of claim 19, wherein, when the computer program is executed by the processing component, the processing component is further caused to perform:
obtaining a training input matrix X′ from a preset dataset;
performing linear projections on the training input matrix X′ to generate a training query matrix Q′ and a training key matrix K′;
calculating a training correlation matrix M′ based on the training query matrix Q′ and the training key matrix K′;
quantizing at least one of the training query matrix Q′ and the training key matrix K′ to calculate a quantized training correlation matrix M′_{q}; and
calculating the temperature adjustment parameter T based on the training correlation matrix M′ and the quantized training correlation matrix M′_{q}.
